(19) United States
(12) Patent Application Publication
(10) Pub. No.: US 2012/0145274 A1
(43) Pub. Date: Jun. 14, 2012

(54) AIR DUCT DEVICE FOR HEAT DISSIPATION

(75) Inventors: ZHEN-XING YE, Shenzhen City (CN); XIAN-XIU TANG, Shenzhen City (CN)

(73) Assignees: HON HAI PRECISION INDUSTRY CO., LTD., Taipei Hsien (TW); HONG FU JIN PRECISION INDUSTRY (ShenZhen) Co., LTD., Shenzhen City (CN)

(21) Appl. No.: 12/978,530

(22) Filed: Dec. 24, 2010

(30) Foreign Application Priority Data
Dec. 14, 2010 (CN) 201010586875.6

(51) Int. Cl. F16L 9/18

(52) U.S. Cl. 138/114

(57) ABSTRACT

An air duct device includes a first air duct, and a second air duct slidably fitting about the first duct. The first air duct axially defines a first passage and defines a row of latching slots along an extending direction of the first passage. The second air axially defines a second passage. A latching hook is formed on the second air duct to be selectively latched to one of the latching slots.

### BACKGROUND

1. Technical Field

The present disclosure relates to an air duct device that can dissipate heat in a device.

2. Description of Related Art

Electronic devices, such as computers, use heat dissipation assemblies for dissipating heat generated by components therein, thus preventing the components from becoming overheated. An air duct device is often used in a computer with a fan to assist in heat dissipation by guiding airflow. However, different sizes of electronic devices need different sizes of air duct devices, creating a need for a flexible air duct device.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of an air duct device, together with a cooling member.

FIG. 2 is an inverted view of FIG. 1.

FIG. 3 is an assembled, isometric view of FIG. 1.

FIGS. 4 to 5 are cross-sectional views of FIG. 3, showing different states of use of the air duct device.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean at least one.

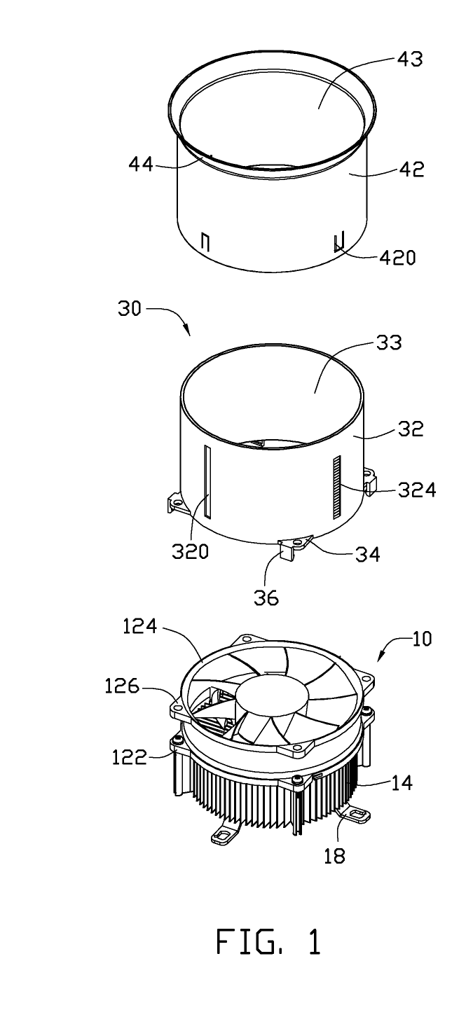

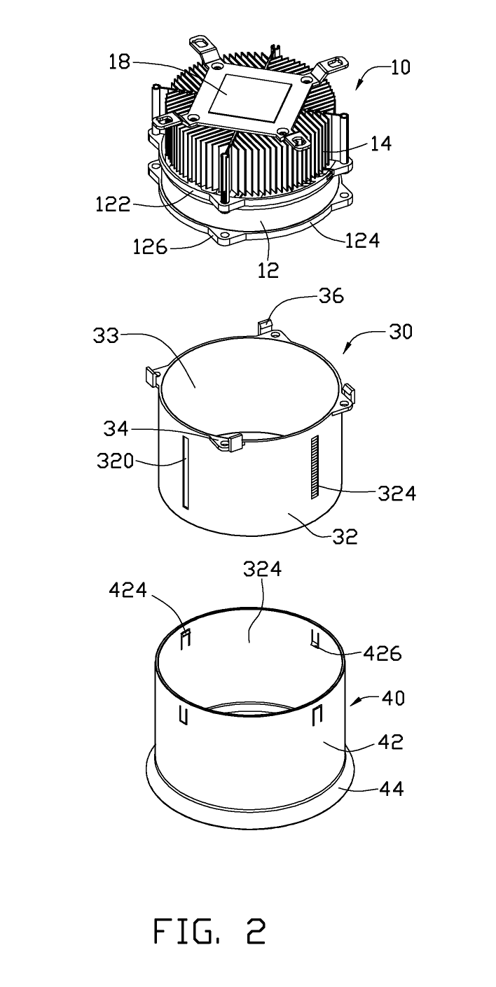

Referring to FIGS. 1 and 2, an exemplary embodiment of an air duct device is provided to conduct airflow for a cooling member 10 mounted in an electronic device (not shown). The air duct device includes a first air duct 30 and a second air duct 40.

The cooling member 10 includes a fan 12 and a heat sink 14. The fan 12 includes a first frame 122 and a second frame 124 opposite to the first frame 122. Four substantially triangular tabs 126 respectively extend from four corners of each of the first and second frames 122 and 124. A plurality of fasteners, such as screws, extends through the tabs 126 of the first frame 122 and engages with the heat sink 14 to fasten the fan 12 to a first end of the heat sink 14. A mounting seat 18 fastened to a second end of the heat sink 14 opposite to the first end, is provided to fasten the cooling member 10 in the electronic device.

The first air duct 30 includes a substantially cylinder-shaped first main body 32. The first main body 32 defines a passage 33 along an axis of the first main body 32. The first main body 32 further defines two slide slots 320 opposite to each other and two rows of latching slots 324 opposite to each other along the axis of the main body 32 in a sidewall of the first main body 32. Four substantially triangular tabs 34 equidistantly extend from a first end of the sidewall of the first main body 32. A hook 36 extends down from each of the tabs 34.

The second air duct 40 includes a substantially cylinder-shaped second main body 42. The second main body 42 defines a passage 43 along an axis of the second main body 42. A trumpet-shaped flange 44 slantingly extends up from a first end of the second main body 42 for increasing airflow of the passage 43. The second main body 42 further equidistantly defines four substantially U-shaped through slots 420 in a sidewall of the second main body 42. Two elastic latching hooks 424 opposite to each other are surrounded by two opposite through slots 420 of the four through slots 420. The latching hooks 424 direct to a second end of the second main body 42 opposite to the first end. Two elastic guiding blocks 426 opposite to each other are surrounded by the other two opposite through slots 420. The guiding blocks 426 direct to the first end of the second main body 42.

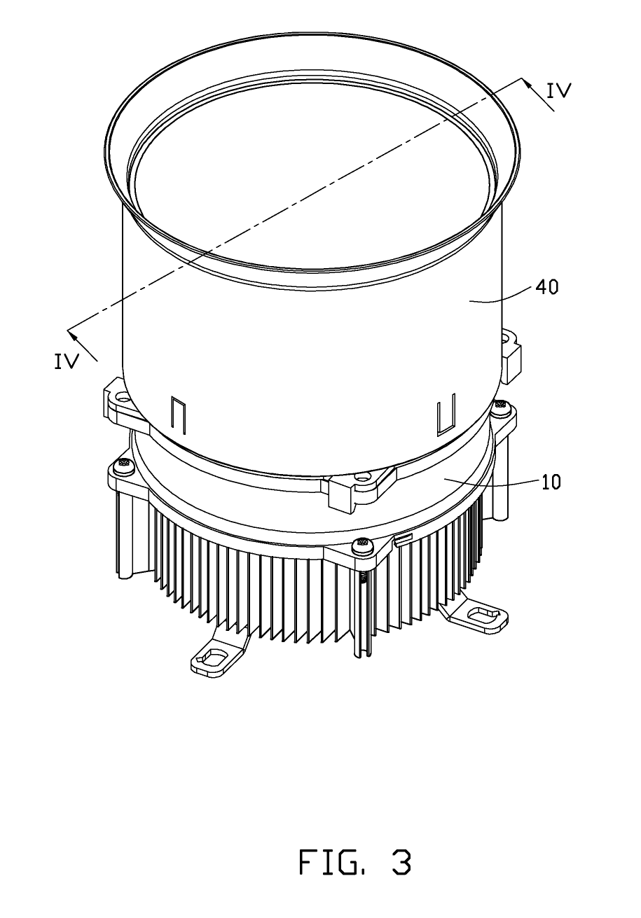

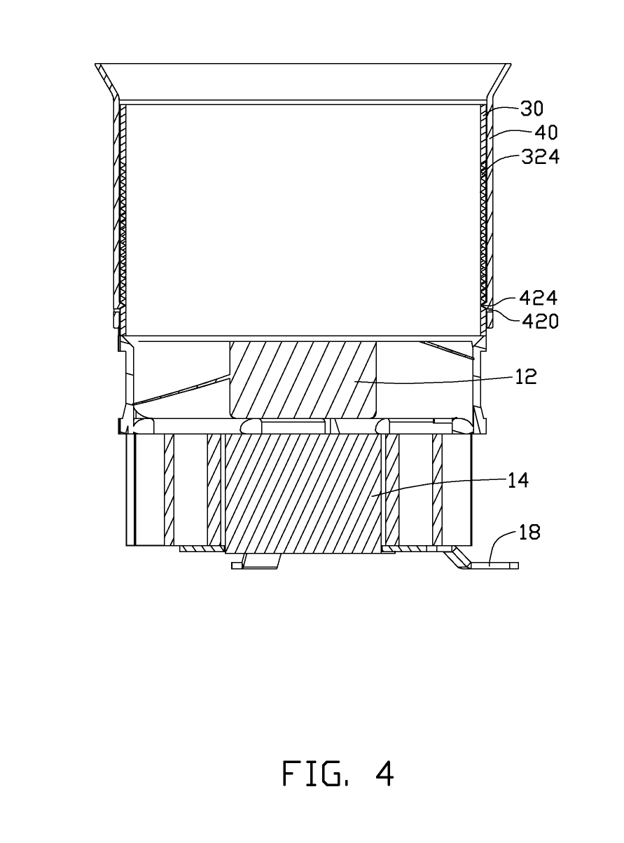

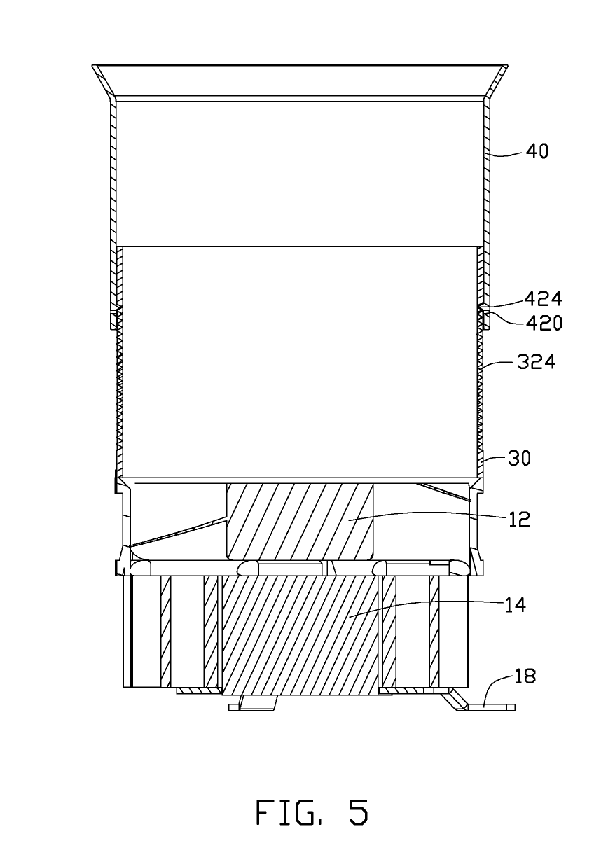

Referring to FIGS. 3 to 5, in assembly, the second main body 42 of the second air duct 40 is fit about the first main body 32 of the first air duct 30 through the passage 43. An outer surface of the sidewall of the first main body 32 resists against an inner surface of the sidewall of the second main body 42. The guiding blocks 426 of the second air duct 40 are slidably engaged in the corresponding slide slots 320 of the first air duct 30, to make the second air duct 40 capable of sliding relative to the first air duct 30 along the slide slots 320. The latching hooks 424 are latched to two corresponding opposite latching slots 324, to fasten the second air duct 40 to the first air duct 30. The tabs 34 of the first air duct 30 resist against the tabs 126 of the second frame 124 of the fan 12. The hooks 36 of the first air duct 30 are latched to bottoms of the tabs 126 of the second frame 124 to fasten the first air duct 30 to the fan 12.

In use, the latching hooks 424 are selectively latched to different two corresponding opposite latching slots 324 to adjust a length of the first air duct 30 exposed from the second air duct 40, thereby changing the size of the air duct device, making it a universal duct system adaptable to many different size electronic devices.

In other embodiments, each tab 34 of the first air duct 30 defines a through hole, and correspondingly each tab 126 of the second frame 124 defines a fastening hole. A plurality of fasteners, such as screws, extends through the through holes of the first air duct 30 and engages in the fastening holes of the second frame 124 to fasten the first air duct 30 to the fan 12.

It is to be understood, however, that even though numerous characteristics and advantages of the embodiments have been set forth in the foregoing description, together with details of the structure and function of the embodiments, the present disclosure is illustrative only, and changes may be made in details, especially in matters of shape, size, and arrangement of parts within the principles of the embodiments to the full extent indicated by the broad general meaning of the terms in which the appended claims are expressed.

1. An air duct device comprising:
a first air duct axially defining a first passage, and defining a row of latching slots in a first sidewall bounding the first passage along an extending direction of the first passage; and
a second air duct slidably fitting about the first air duct, and axially defining a second passage, the second air duct comprising a latching hook formed on a second sidewall bounding the second passage, to be selectively latched to one of the latching slots.

2. The air duct device of claim 1, wherein the latching slots are defined in an external surface of the first sidewall of the first air duct.

3. The air duct device of claim 1, wherein the second air duct defines a substantially U-shaped through slot, the latching hook is surrounded by the through slot.

4. The air duct device of claim 1, wherein the first air duct defines a slide slot along the extending direction of the first passage, a guiding block is formed on the second sidewall of the second air duct, to slidably engage in the slide slot.

5. The air duct device of claim 4, wherein the slide slot is defined in an external surface of the first sidewall of the first air duct.

6. The air duct device of claim 4, wherein the second air duct defines a substantially U-shaped through slot, the guiding block is surrounded by the through slot.

7. The air duct device of claim 1, wherein a plurality of tabs extends from one end of the first air duct, a hook extends from each of the plurality of the tabs to be latched to a fan.

8. The air duct device of claim 1, wherein a trumpet-shaped flange extends outward from one end of the second air duct to increase an air inlet of the second passage.

9. The air duct device of claim 1, wherein the first and second air ducts are both cylinder-shaped.
